(19) United States
(12) Patent Application Publication
(10) Pub. No.: US 2015/0149654 A1
(43) Pub. Date: May 28, 2015

(54) Modular Analog Frontend

(71) Applicant: Broadcom Corporation, Irvine, CA (US)

(72) Inventors: Davide Vecchi, Utrecht (NL); Jan Mulder, Houten (NL); Franciscus Maria Leonardus Van der Goes, The Hague (NL); Erol Arslan, Beveren (BE); Michael Randall Grimwood, Palo Alto, CA (US)

(73) Assignee: Broadcom Corporation, Irvine, CA (US)

(21) Appl. No.: 14/132,596

(22) Filed: Dec. 18, 2013

Related U.S. Application Data
(60) Provisional application No. 61/907,627, filed on Nov. 22, 2013.

(51) Int. Cl. H04L 29/06

(52) U.S. Cl. CPC H04L 65/608
USPC 709/231

(57) ABSTRACT

A system may include a first stage comprising first signaling components for a first protocol, and a second stage comprising second signaling components for the first protocol and a second protocol. The system may further include logic configured to receive an incoming data stream, and determine a stream protocol for the data stream. The logic may be further configured to, responsive to the determination, activate the at least a portion of the first stage when the stream protocol is compliant with the first protocol, and when the stream protocol is compliant with the second protocol, deactivate the first stage.

### PRIORITY CLAIM

This application claims priority to U.S. Provisional Application Ser. No. 61/907,627, filed Nov. 22, 2013, which is incorporated herein by reference in its entirety.

### TECHNICAL FIELD

This disclosure relates to networking protocol compatibility. This disclosure also relates to a modular analog frontend for multiple networking protocols.

### BACKGROUND

Data networks interconnect computing devices and facilitate information exchange. Multiple networking protocol standards are in use on these data networks. The varied standards offer differing levels of speed and performance. Some devices offer compatibility with multiple protocols. These devices may be implemented in a variety of networking environments.

### BRIEF DESCRIPTION OF THE DRAWINGS

FIG. 1 shows an example device.

FIG. 2 shows an example analog frontend.

FIG. 3 shows an example modular analog frontend (MAFE).

FIG. 4 shows an example MAFE.

FIG. 5 shows an example MAFE.

FIG. 6 shows example logic for operation of a MAFE.

### DETAILED DESCRIPTION

The disclosure below concerns techniques and architectures for facilitating compatibility with multiple networking protocols via a modular analog frontend (MAFE). The MAFE may be placed in multiple configurations to allowing compatibility with multiple networking protocols. The MAFE also allows resource conservation by placing hardware unused by a given protocol in an inactive or low power state. For example, a first protocol may implement first and second amplifier stages of the MAFE, and a second protocol may implement the first amplifier stage. When communicating over the second protocol, the MAFE may implement the first stage and turn off power to the second amplifier stage.

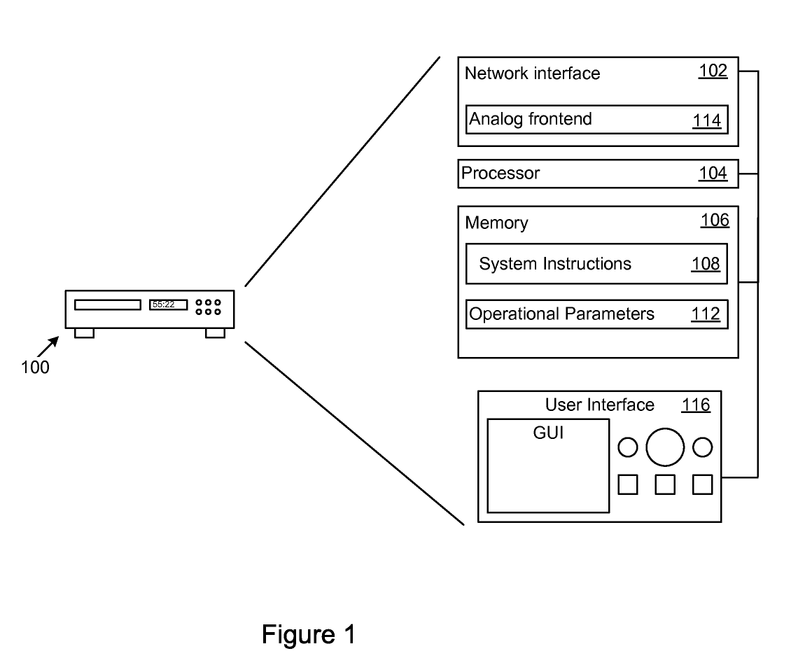

The example device described below provides an example context for explaining the techniques and architectures to support compatibility with multiple networking protocols via a MAFE. FIG. 1 shows an example device 100. In one example, the device may be a communication device, such as a laptop computer, router, or server. However, the device may be virtually any device implementing a network interface compatible with multiple protocols. For example, backbone networking hardware, a gaming console, a television set-top box, or other networking device may use a MAFE.

The device 100 may include a network interface 102 to support network communications over multiple protocols, and one or more processors 104 to support execution of applications and operating systems, and to govern operation of the device. Further, the one or more processors 104 may run processes to determine the transmission protocol that is active on the interface 102. The device 100 may include memory 106 for execution support and storage of system instructions 108 and operational parameters 112. The communication device 100 may include a user interface 116 to allow for user operation of the device. An analog frontend 114 within the network interface 102 may also be included to support transmission and reception of signals. The analog frontend 114 may include amplifiers to adjust input signal levels to useable output levels. The analog frontend may further include analog-to-digital converter (ADC).

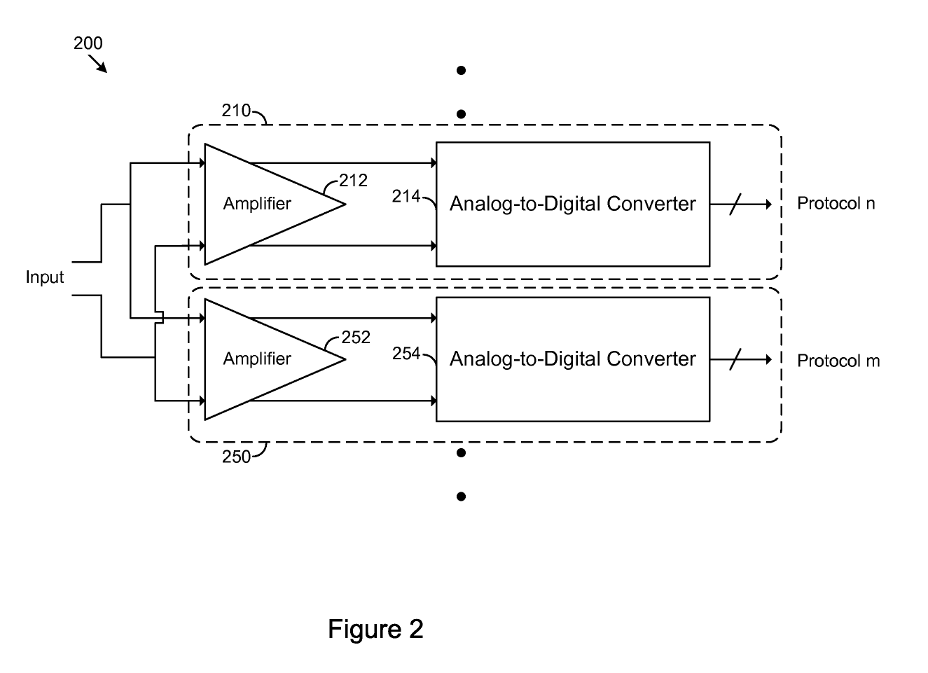

FIG. 2 shows an example analog frontend (AFE) 200. The AFE includes multiple parallel sets 210, 250 of signaling components to allow for multiple protocol reception of signals. The individual sets 210, 250 may be associated with different protocols. Incoming signals may be split and fed to the sets 210, 250 in parallel. The sets 210, 250 may determine if the received signal corresponds to their associated protocol. The set 210, 250 that corresponds to the protocol of the incoming signal may handle the decoding process. In some cases, the parallel sets 210, 250 may include similar components. The complexity and size of the AFE 200 may be increased by the repeated similar components. The increased size and complexity of the AFE 200 may be associated with increased manufacturing cost and parasitic capacitance. Increased parasitic capacitance may be associated with signal degradation. In some cases, it may be advantageous to reduce the number of similar repeated components on the AFE 200.

The sets 210, 250 may include amplifiers 212, 252, e.g. programmable gain amplifiers, continuously variable gain amplifiers, and or other amplifier types. The amplifiers may be implemented to amplify a signal experiencing a determined maximum level of loss during transmission. For example, an amplifier may be programmed to supply a gain to amplify a signal experiencing loss from traversing a 100 m long ethernet cable. The amplifier may be implemented to help ensure that a trip of a given length may result in a usable signal.

The sets 210, 250 may also include ADCs 214, 254. ADCs may implement different resolutions and sample rates in order to support modulation schemes associated with different protocols. For example, a modulation scheme associated with one protocol may require a resolution of 10 bits per 800 MHz sample and a modulation scheme associated with a different protocol may require a resolution of 8 bits per 3200 MHz sample. The various ADCs 214, 254 may support different resolutions and sample rates. In some implementations, other modulation schemes may be used for example, the ADCs 214, 254 may be configured to support different resolutions and sample rates. For example, the 6 bit and 4 bit ADCs may be combined to provide a single 10 bit ADC. Other combinations of resolutions and sample rates may be implemented. To achieve the required resolution and sample rate, ADCs may be implemented in series, parallel, or some combination of both series and parallel.

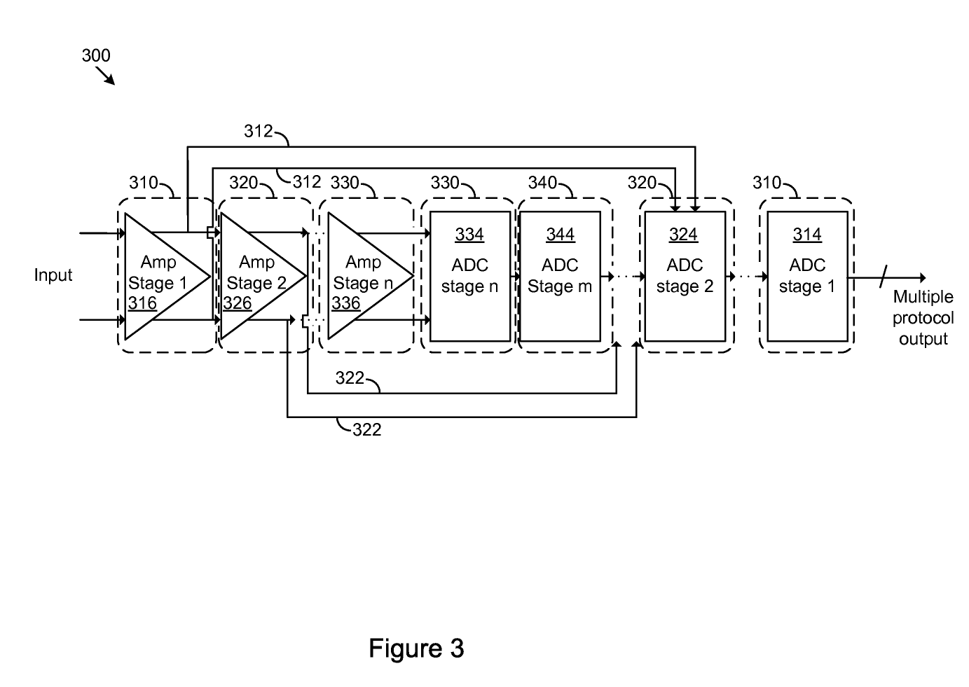

FIG. 3 shows an example MAFE 300. The MAFE 300 may include multiple stages 310, 320, 330, 340 associated with operation under various protocols. The MAFE may further include controls 350 to support stage and/or partial stage activation/deactivation. For example, stages 310 and 320 may be active during operation of a first protocol. Stages 310, 320, and 330 may be active during operation of a second protocol. Stage 310, 320, 330, and 340 may be active during operation of a third protocol. Other stages and/or protocols may be added. Additionally or alternatively, stages and/or protocols may be removed. Inactive stages may be bypassed during protocol via connections 312, 322. As discussed below, connections 312, 322 may include bypass networks to maintain parameters, e.g. input/output impedance, system noise figures, and/or other parameters, of the MAFE among multiple bypass configurations. Components of the stages 310, 320, 330, 340 may be used by multiple protocols. In some cases, component reuse may reduce the area consumed by the MAFE 300 in an IC. The reduced area may reduce noise and parasitic capacitance contributions from the MAFE 300.

The stages 310, 320, 330, 340 may include ADCs 314, 324, 334, 344 and amplifiers 316, 326, 336, e.g. programmable gain amplifiers, continuously variable gain amplifiers, and/or other amplifier types. In some cases, a stage may not include an amplifier or an ADC. For example, a first protocol may have similar noise and/or signal level guidelines to a second protocol. In some cases, the first protocol and second protocol may share amplifier stages, e.g. amplifiers 316, 326, 336. In some cases, the first protocol may use a different number of bits per symbol and/or symbol group than that of the second protocol. The first and the second protocol may not share some ADCs. For example, ADCs 314, 324, 334 may be shared by the first and second protocols, but ADC 344 may not be shared by the first and second protocols, e.g. ADC 344 may be bypassed during operation of the second protocol.

ADCs 314, 324, 334, 344 may operate in series to allow for differing numbers of bits to be implemented in different configurations. For example, the ADCs may include flash ADCs producing a number of bits in series, e.g. a first ADC that measures 2 bit, a second that measures 2 bits, a third that measure 3.5 bits, and a fourth that measures 1 bit. Other combinations may be used. In some cases, a flash ADC or multiple flash ADCs measuring a number of bits may be followed by a successive approximation register (SAR) ADC measuring the remaining bits. For example a first flash ADC may measure 1.5 bits, a second flash ADC may measure 1 bit, and a SAR ADC may measure 7 bits. Other types and combinations of ADCs may be implemented.

In some implementations, stages may be activated/deactivated in response to conditions within a protocol. For example, when noise conditions become favorable, usage of a given number of amplifier stages may be relaxed for a given protocol. Physical conditions may also affect stage usage within a protocol. For example, a protocol may support cables of length B. To support the cables of length B, the protocol may implement a given amplifier power. The given amplifier power may be achieved through multiple stages of smaller amplifiers. In some cases, a system may be able to determine a cable length and/or a cable length may be indicated to the system via an external detection system. If the cable length is at a second length C that meets determined criteria, e.g. below a threshold length A, within a length range, or other length criteria, the system may adjust the number of amplifiers used. In some cases, the number of amplifier stages may be decreased. Decreasing the number of amplifier stages may decrease the noise contribution from amplification. In some cases, the number of amplifier stages may be increased. For example, the system may adjust to support cable lengths greater than B, e.g. greater than the protocol-determined maximum length. In some implementations, the number of amplification stages may be dynamically increased or decreased in response to signal conditions. For example, a high detected noise floor may cause the MAFE 300 to reduce the number of amplification stages in operation for a given protocol. A low signal level may cause the MAFE 300 to increase the number of active amplification stages. The MAFE 300 may maintain multiple profiles for different connection conditions/protocols. The MAFE 300 may activate/deactivate stages or stage portions in accord with the connection profiles.

In some implementations, the amplification stages 316, 326, 336 may not provide equal levels of amplification. In some cases, to increase/decrease the level of amplification the MAFE 300 may activate a stage and deactivate a second stage, e.g. perform a substitution.

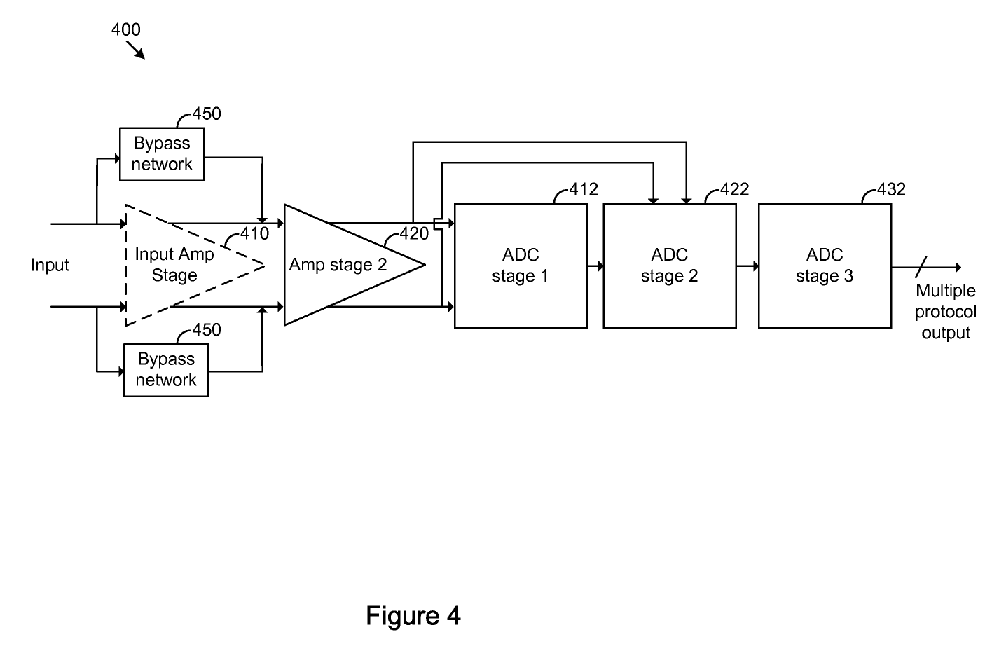

FIG. 4 shows an example MAFE 400. The example MAFE 400 includes bypass networks 450 to support a bypass of input amplifier stage 410. In some cases, bypass networks 450 may allow for a bypass of an input amplifier stage 410 and mitigate effects of the bypass. For example, changing the input amplifier may affect the input impedance and/or noise performance of the MAFE 400. The bypass network may maintain input impedance in cases where the input amplifier stage 410 is bypassed to allow a second amplifier stage 420 to act as an input amplifier. In some cases, the input amplifier stage 410 may allow for a high or highest level of amplification. In some cases, the amplifier stage 410 may contribute to the noise floor of the incoming signal. Bypassing stage 410 may allow for large gains in power consumption reduction and noise floor reduction. Bypass networks may be applied to other stages and components of the MAFE 400. For example, although not shown, bypass networks may be used to maintain output characteristics of ADC stages 412, 422, 432 and/or internal parameters when intermediate stages are bypassed within the MAFE 400.

In some implementations, an input amplifier stage 410 may be programmable and/or otherwise adaptable. The input amplifier stage 410 may allow for multiple gain ranges and channel shapes. The adaptability of the input amplifier stage 410 may accommodate multiple protocols. Other amplifier stages, e.g. second amplifier stage 420 or amplifiers 316, 326, 336, may be implemented with similar adaptability.

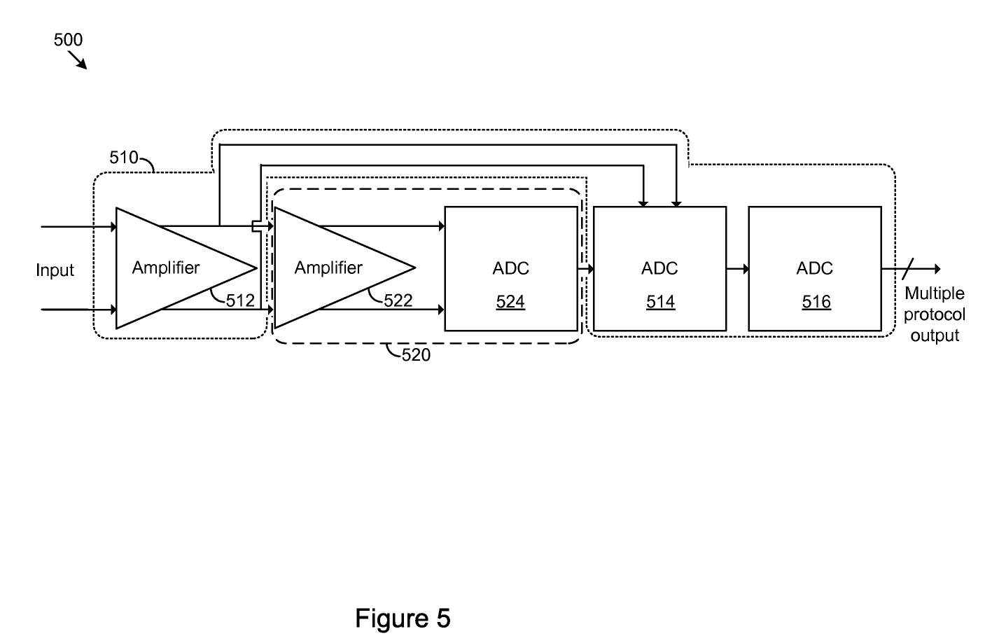

FIG. 5 shows an example MAFE 500. The example MAFE 500 may support multiple protocols including ethernet modes IEEE 10GBASE-T and IEEE 40GBASE-T. 10GBASE-T may use more amplification power and ADC bits than 40GBASE-T. The MAFE 500 may operate in multiple stages 510, 520. Stage 510 may include amplifier 512 and ADCs 514, 516. Stage 520 may include amplifier 522 and ADC 524. For 10GBASE-T, stages 510, 520 may be active. For 40GBASE-T operation, stage 510 may be active and stage 520 may be deactivated. In some cases, reuse of stage 510 may reduce area consumption associated with dual 10GBASE-T and 40GBASE-T support. In some cases, 50% or greater area reduction

10GBASE-T may support cable lengths of 100 m. 40GBASE-T may support cable lengths of 30 m. The MAFE may include controls 550 to determine if the cable length of a 10GBASE-T stream is 30 m or less. In some cases, the controls 550 may deactivate amplifier 522 of stage 520 when the cable length is 30 m or less. For these shorter cables, the amplification usage of 10GBASE-T may be similar to that of 40GBASE-T.

Additionally or alternatively, MAFEs may support other protocols. For example, the multiple stages of a MAFE may support 1GBASE-T, 10GBASE-T and 40GBASE-T. The MAFEs may also be implemented in multi-lane ethernet protocols such as 100G and 400G protocols.

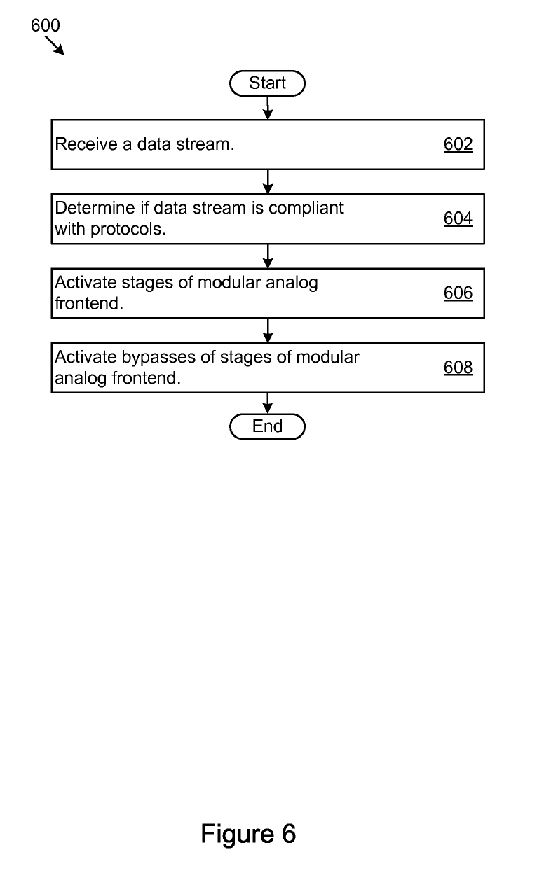

FIG. 6 shows example logic 600 for operation of a MAFE. The example logic may be implemented and/or partially implemented within the controls of a MAFE, e.g. controls 350, 550. The MAFE may receive a data stream at an input (602). In some cases the input may be an input amplifier stage. Further, the logic 600 may include sensors to detect the data stream at the input. The logic 600 may determine if the data stream is compliant with one or more of the protocols or connection profiles of the stages of the MAFE (604). For example, the logic may make a protocol determination and then determine if the activation profile of the MAFE may be optimized further. For example, if the length of the cable on which the data stream is arriving is below a threshold length the logic 600 may reduce the number of amplifier stages that are slotted for activation. The once the data stream protocol and/or connection profile are determined, the logic may activate stages in accord with the determinations (606). The logic may activate bypasses of stages and/or partial stages that have been deactivated (608).

The methods, devices, and logic described above may be implemented in many different ways in many different combinations of hardware, software or both hardware and software. For example, all or parts of the system may include circuitry in a controller, a microprocessor, or an application specific integrated circuit (ASIC), or may be implemented with discrete logic or components, or a combination of other types of analog or digital circuitry, combined on a single integrated circuit or distributed among multiple integrated circuits. All or part of the logic described above may be implemented as instructions for execution by a processor, controller, or other processing device and may be stored in a tangible or non-transitory machine-readable or computer-readable medium such as flash memory, random access memory (RAM) or read only memory (ROM), erasable programmable read only memory (EPROM) or other machine-readable medium such as a compact disc read only memory (CDROM), or magnetic or optical disk. Thus, a product, such as a computer program product, may include a storage medium and computer readable instructions stored on the medium, which when executed in an endpoint, computer system, or other device, cause the device to perform operations according to any of the description above.

The processing capability of the system may be distributed among multiple system components, such as among multiple processors and memories, optionally including multiple distributed processing systems. Parameters, databases, and other data structures may be separately stored and managed, may be incorporated into a single memory or database, may be logically and physically organized in many different ways, and may implemented in many ways, including data structures such as linked lists, hash tables, or implicit storage mechanisms. Programs may be parts (e.g., subroutines) of a single program, separate programs, distributed across several memories and processors, or implemented in many different ways, such as in a library, such as a shared library (e.g., a dynamic link library (DLL)). The DLL, for example, may store code that performs any of the system processing described above.

Various implementations have been specifically described. However, many other implementations are also possible.

What is claimed is:

1. A device comprising;
a first stage comprising first signaling components for a first protocol and a second protocol;
a second stage comprising second signaling components for the first protocol; and
logic configured to:
receive an incoming data stream;
determine a stream protocol for the data stream; and
responsive to the determination:
when the stream protocol is compliant with the first protocol, activate the at least a portion of the second stage; and
when the stream protocol is compliant with the second protocol, deactivate the second stage.

2. The device of claim 1, further comprising a bypass circuit configured to bypass the second stage when activated.

3. The device of claim 2, where the logic is further configured to activate the bypass when the stream protocol is compliant with the second protocol.

4. The device of claim 1, where:
the first signaling components comprise a first converter element configured to produce a first set of bits based on the data stream; and
the second signaling components comprise a second converter element configured to produce a second set of bits based on the data stream.

5. The device of claim 4, where:
the first set of bits is compliant with the first and second protocols; and
the second set of bits is compliant with the first protocol.

6. The device of claim 1, where:
the first signaling components comprise a first amplifier configured to amplify the data stream at a first level; and
the second signaling components comprise a second amplifier configured to amplify the data stream at a second level.

7. The device of claim 6, where the second level is greater than the first level.

8. The device of claim 6, where the second amplifier is configured to amplify the data stream after amplification via the first amplifier.

9. The device of claim 6, where the second amplifier is configured to amplify the data stream to a second power level via amplification from an incoming power level of the data stream.

10. The device of claim 1, where:
the first protocol is configured to operate at a first bit rate; and
the second protocol is configured to operate at a second bit rate different from the first.

11. The device of claim 10, where the logic is further configured to determine a stream bit rate of the data stream to determine the stream protocol.

12. The device of claim 1, where the logic is further configured to:
receive the data stream over an input cable;
determine a cable length for the input cable; and
responsive to the determination of the cable length, forgo activation of an amplifier of the second signaling components when the stream protocol is compliant with the second protocol.

13. A method, comprising:
receiving, at a frontend, a data stream;
determining that the data stream is compliant with a first protocol;
activating a first stage of the frontend, the first stage compliant with the first protocol and a second protocol; and
bypassing a second stage of the frontend, the second stage compliant with the second protocol.

14. The method of claim 13, where determining that the data stream is compliant with the first protocol comprises determining a bit rate of the data stream.

15. The method of claim 13, where bypassing the second stage comprises bypassing a converter element configured to generate a set of bits compliant with the second protocol.

16. The method of claim 13, where:
the first protocol comprises a IEEE 40GBASE-T compliant protocol; and
the second protocol comprises a IEEE 10GBASE-T compliant protocol.

17. The method of claim 13, where bypassing comprises changing an input amplifier of the frontend from a second amplifier of the second stage to a first amplifier of the first stage.

18. The method of claim 17, where bypassing comprises activating a bypass network to maintain an input parameter of the frontend.

19. A device, comprising:
a frontend comprising:
a first amplifier stage configured to amplify an incoming data signal at a first level, the first level being compliant with a first protocol;
a second amplifier stage configured to amplify the incoming data signal at a second level, the second level being compliant with a second protocol;
a first converter element configured to generate a first set bits based on the incoming signal, the first set of bits compliant with the first and second protocols; and
a second converter element configured to generate a second set of bits based on the incoming signal, the second set of bits compliant with the second protocol; and
logic, in operative communication with the frontend, the logic configured to:
determine a stream protocol for the incoming signal; and
responsive to the determination:
when the stream protocol is compliant with the second protocol, activate the second amplifier stage and the second converter element; and
when the stream protocol is compliant with the first protocol, deactivate the second amplifier stage and the second converter element.

20. The device of claim 19, where:
the first protocol is configured to operate at a first bit rate;
the second protocol is configured to operate at a second bit rate different from the first; and
the logic further configured to determine the stream protocol based on the bit rate of the stream.
